(19) United States
(12) Patent Application Publication
(10) Pub. No.: US 2012/0280920 A1
(43) Pub. Date: Nov. 8, 2012

(54) TACTILE DISPLAY USING DISTRIBUTED FLUID EJECTION

(76) Inventors: Warren Jackson, San Francisco, CA (US); Ping Mei, San Jose, CA (US)

(21) Appl. No.: 13/259,236

(22) PCT Filed: Jan. 29, 2010
(86) PCT No.: PCT/US10/22554

§ 371 Date: Jan. 31, 2012

(51) Int. Cl. G06F 3/041

(52) U.S. Cl. 345/173

(57) ABSTRACT

A tactile display for providing tactile feedback has a touch surface layer formed of a plurality of pixels. Each pixel has an aperture for ejecting a fluid, and a valve for opening and closing the aperture. The valve is operable to modulate the fluid ejection through the aperture at a frequency selected for detection by the somatic sensors of a human finger.

### BACKGROUND

User interfaces for telecommunications and computerized devices traditionally have been focused on the visual and auditory functions of human senses. Many televisions, computers and game stations have high-resolution visual displays and capabilities for stereo or multi-channel audio output. The other human senses, however, are largely ignored and not utilized in user interfaces. In particular, the sense of touch, which is a critical part of how people experience the world, is typically neglected in user interface designs. There have been some limited efforts in adding “touch” to user interfaces in relatively crude ways. For instance, to enhance the realism of computer games, some game controllers incorporate a motor with a rotating unbalanced load that shakes the hands of the player to indicate a collision or explosion. Also, it has been demonstrated that ultrasonic vibration of a glass plate can change the friction between a finger and the glass surface due to entrainment of air caused by the ultrasonic vibration. Attempts have been made to use temporal variations of such friction changes to mimic the sensation of feeling the texture of an object by touch.

### BRIEF DESCRIPTION OF THE DRAWINGS

Some embodiments of the invention are described, by way of example, with respect to the following figures:

FIG. 1 is a schematic view of a display system with a tactile display in accordance with an embodiment of the invention;

FIG. 2 is a schematic top view of a portion of a contact surface of the tactile display of FIG. 1;

FIG. 3 is a schematic cross-sectional view of one embodiment of the tactile display;

FIG. 4 is a schematic cross-sectional view of another embodiment of the tactile display;

FIG. 5 is a schematic cross-sectional view of yet another embodiment of the tactile display;

FIG. 6 is an illustration of ah embodiment of the tactile display being used to provide tactile feedback to a finger of a user;

FIG. 7 is a schematic cross-sectional view of an embodiment of the tactile display with a membrane-covered contact surface; and

FIG. 8 is a schematic cross-sectional view of an embodiment of the tactile display with a diffuser layer as its contact surface.

### DETAILED DESCRIPTION

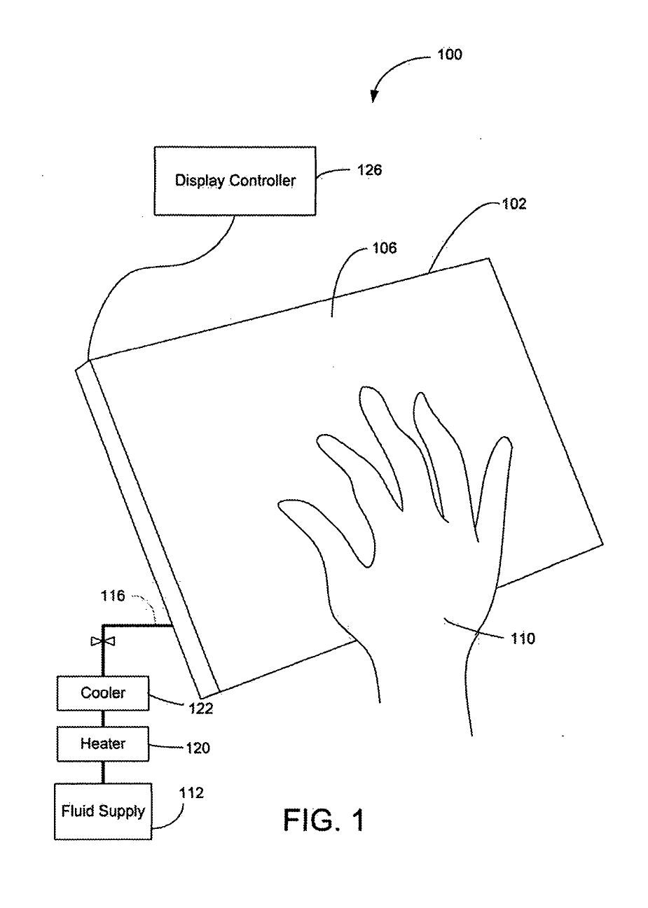

FIG. 1 shows an embodiment of a display system 100 in accordance with the invention for providing tactile feedback to a user. As used herein, the word “display” is used broadly to mean an output device that presents information for perception by a user, and such information may be visual, tactile or auditory. The display system 100 has a tactile display device 102 that uses distributed fluid ejection through a contact surface 106 to provide tactile sensations to the fingers of the user's hand 110 touching the contact surface. The fluid used may be a liquid such as water, or a gas such as air. To provide the fluid needed for the operation, the system includes a fluid supply 112, which is connected to the display device 102 via a pipe 116, a hose, or other suitable conduit. The fluid is compressed or pressurized such that it can be ejected under a selected pressure. A heater 120 and/or a cooler 122 may be used to heat or cool the fluid to adjust the temperature of the fluid ejected by the tactile display 102. The system further includes a controller 126 that is connected to the display device 102 for controlling the fluid ejection operation of the display device.

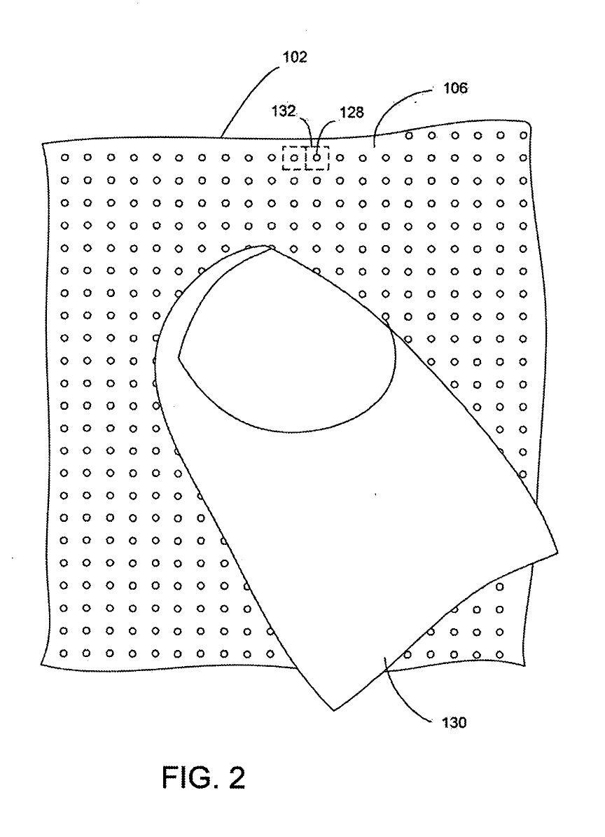

As shown in FIG. 2, the distributed fluid ejection may be carried out using a plurality of apertures 128 formed in or underneath, the contact surface 106 of the tactile display 102. In the illustrated embodiment, the apertures 128 are arranged in vertical columns and horizontal rows. Nevertheless, different aperture distribution patterns may be used. In this regard, the contact surface 106 may be viewed as being divided into a plurality of pixels 132, with each pixel defined around an aperture 128. As described in greater detail below, the ejection of fluid through the apertures 128 may be controlled to vary from pixel to pixel to provide a spatially and temporally varying fluid ejection pattern across the contact surface 106. The spatial resolution of the fluid ejection through the distributed apertures 128 allows different fingers of the user to receive different tactile sensations at the same time.

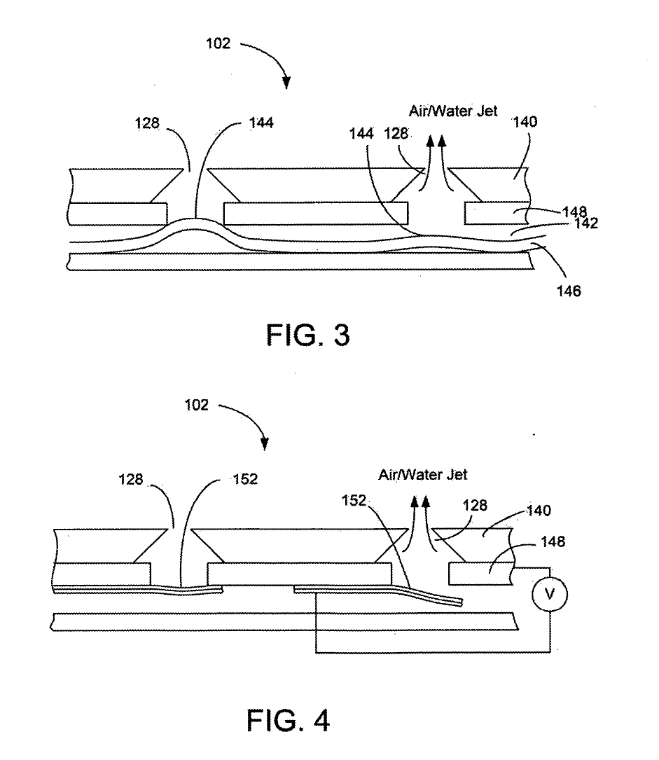

FIG. 3 shows, in a cross-sectional view, an embodiment of the tactile display device 102. The display device 102 includes an aperture layer 140 in which the apertures 128 for fluid ejection are formed. A channel 142 in the display device 102 conducts the pressurized fluid to the apertures 128. Bach aperture 128 has an associated valve 144 operable to close or open the aperture to modulate the fluid flow through the aperture. The modulation of the fluid flowthrough the aperture may be performed at a frequency and amplitude that can be perceived by somatic sensors in the human fingers. The desired frequency range and amplitude depend on the types of sensor cells intended to be stimulated by the modulated fluid ejection. For example, the Merkel cells in a human finger, which are used for detecting form and texture, have a spatial resolution of about 0.5 mm, a sensing frequency range of 0-100 Hz with a peak sensitivity at 5 Hz, and a mean threshold of activation amplitude of 3.0 μm. In contrast, the Meissner cells in a human finger, which are used for motion detection and grip control, have a spatial resolution of 3 mm, a detection frequency range of 1-300 Hz with a peak sensitivity at 50 Hz, and a mean threshold of 6 μm, which is small than that of the Merkel cells. Other types of somatic sensors, such as the Pacinian and Ruffini cells, have their own respective spatial resolutions, frequency ranges, and activation thresholds.

In some embodiments of the invention, the fluid ejection modulation frequency and flow volume are selected to facilitate detection by the Merkel and Meissner cells. For instance, the cycling frequency of the valve may be selected to he from 0-1000 Hz, and the fluid pressure and valve opening may be controlled to provide a sufficient fluid ejection volume such that the user's finger feels a vibration amplitude of several to tens of microns.

The separation between the apertures 128 depends on the desired spatial resolution of the tactile display 102. In some embodiments, it may be chosen to match the spatial resolution of the Merkel or Meissner cells. For example, the distance between two adjacent apertures may be 0.5 mm, which is the resolution of the Merkel cells, or a smaller distance, such as 0.3 mm, to achieve a finer resolution. The high spatial resolution of tactile display allows the display device to generate detailed tactile information across the contact surface to realistically mimic the touch and feel of a real object.

The valve for controlling the fluid flow through an aperture may be implemented in various ways. For example, in the embodiment shown in FIG. 3, the valve 144 comprises a movable diaphragm 146. When the diaphragm 146 is drawn towards the aperture plate 140, it closes the aperture 128 and prevents the fluid from passing through. The movement of the diaphragm valve 144 may be by means of an electrostatic force induced by applying a voltage difference between the diaphragm 146 and an electrode 148 on the aperture plate 140.

FIG. 4 shows another embodiment of the display device 102 that uses a different implementation of the valve. In this embodiment, the valve for opening or closing an aperture 128 is in the form of a flap valve 152. The flap of the valve 152 may be bent away from the aperture 128 to leave the aperture open, or drawn towards the aperture to close the aperture. The operation of the flap valve 152 may be by means of an electrostatic force caused by a voltage difference applied to the valve flap and an electrode 148 at the aperture plate 140. In some embodiments, such a flap valve is capable of being operated up to a frequency of 500 Hz, which is sufficient to cover the frequency ranges to which the Merkel and Meissner cells are sensitive.

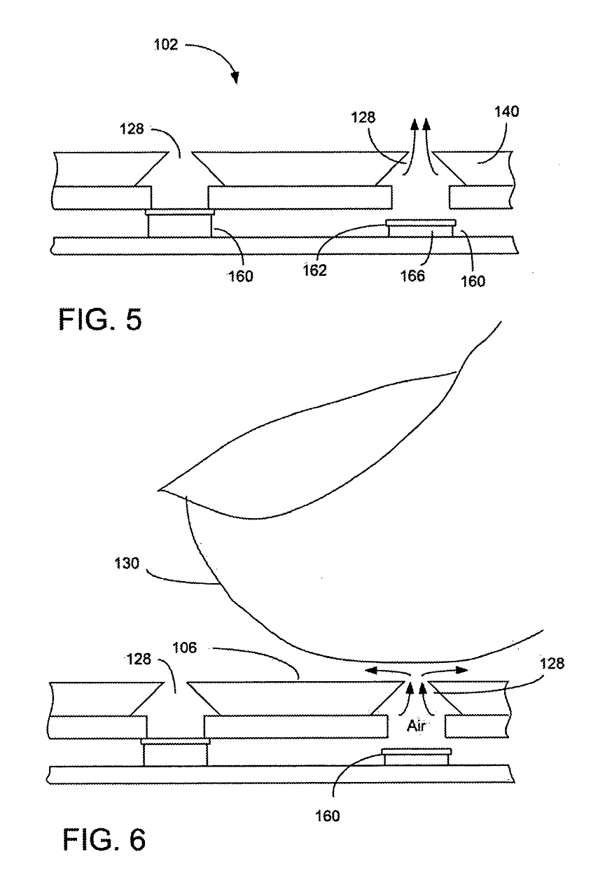

FIG. 5 shows yet another embodiment of the display device using another type of valves. In this embodiment, the valve 160 includes a valve member 162 coupled to an actuator 166 that has a variable height When the actuator 166 is at an extended height, the valve member 162 is placed in contact with the bottom of the aperture plate 140 and seals the aperture 128. When the actuator 166 is at a reduced height, the valve member 162 is disengaged from the aperture plate; leaving the aperture 128 open. The actuator 166 may be formed of an electro-active polymer, which changes its dimension in response to a voltage applied across it. It should be noted that the embodiments of FIGS. 2-5 are only examples of the valve types that may be used, and other types of valves with suitable dimensions and cycling capabilities can also be used to implement the fluid ejection pixels of the display device.

As mentioned above, the controlled flow of a pressurized fluid through the distributed apertures provides tactile feedback to a hand of a user touching the display surface. The fluid may be air, or a different type of fluid, such as water. In some embodiments, the ejected fluid comes into direct contact with the user's finger. In the illustrated embodiment of FIG. 6, the fluid used is air. When, the valve 160 opens, compressed air goes through the aperture 128 and is felt by the finger 130. When the valve 160 is controlled to open and close at a selected frequency, air exits the aperture in a pulsated way. The pulsation of the air jet is sensed by the somatic sensors of the finger 130. In addition, the ejected air may form an air film squeezed between the finger and the contact surface 106. This film may alter the contact resistance or friction between the finger and the contact surface. As each aperture 128 may generate an air jet at its own frequency arid amplitude separately from the other apertures, the friction may be modulated to change from pixel to pixel.

Depending on the separations between the apertures, the finger may cover multiple apertures at the same time. The combination of the output of the covered apertures, each of which may provide a pulsated air jet at a different frequency and flow rate, may provide tactile sensations that may be interpreted as texture. Moreover, by heating and/or cooling the compressed air supplied to the tactile display, the temperature of the ejected air can be modified. Thus, the air jets produced by the apertures can not only stimulate tactile sensations to mimic the shape and surface texture of an object but also indicate the temperature of the object, thus enhancing the realism of the tactile feedback.

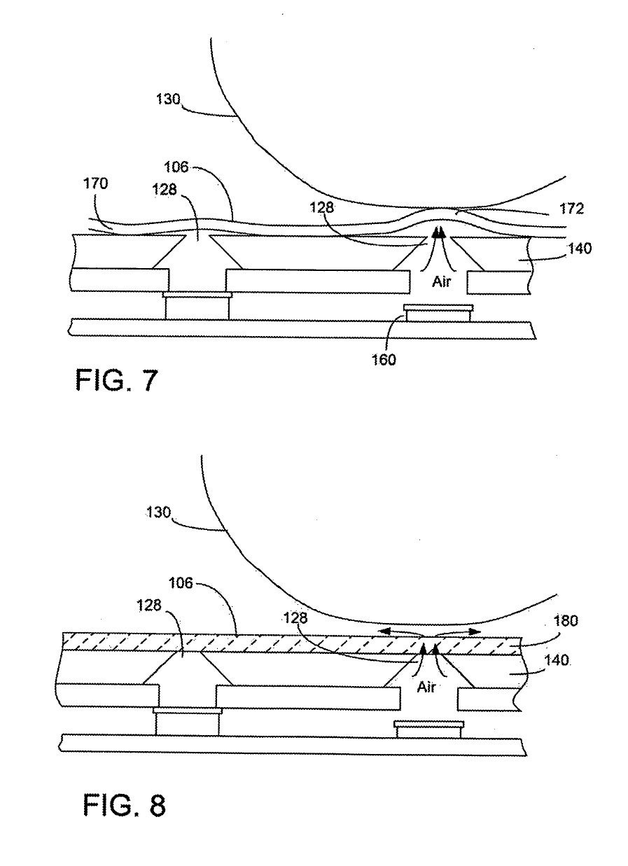

FIG. 7 shows another embodiment in which the user's finger does not directly come in touch with ejected fluid. In this embodiment, the touch surface 106 is the surface of a flexible membrane 170 that covers the aperture plate 140. When the valve 160 is in its open position, pressurized fluid is pushed through the aperture and causes a bump 172 to be formed in the membrane 170 over the aperture. When the valve 160 is closed, or when the valves of other apertures are opened, the pressure of the fluid under the bump 172 is released and the bump is reduced in size. Thus, the portion of the membrane covering the aperture will move up and down in response to the operation the valve 160. The localized vibration of the membrane may be perceived by the somatic sensors of the finger 130.

FIG. 8 shows another embodiment in which the fluid flow ejected by the apertures is diffused. In this embodiment, the contact surface 106 is formed by a layer 180 of a porous material, such as sintered glass or porous plastic. The fluid used may be compressed air. The porous layer 180 covers the apertures 128 formed in the aperture plate 140. The air jet ejected through an aperture 128 is diffused by the porous layer 180. Due to the diffusion, the ejected air is distributed more evenly in the regions between the apertures, which may facilitate the modulation of the contact resistance or friction between the finger 130 and the contact surface 106 to provide improved shear tactile sensations. In addition, the modulated air jet also generates pulsations in the direction normal to the contact surface for stimulating tactile sensations of the finger. The porous layer 180 also prevents direct exposure of the apertures 128 such that contaminants such as dirt would not enter the air system through the apertures.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A tactile display for providing tactile feedback, comprising:
a touch surface layer having a plurality of pixels, each pixel having an aperture for ejecting a fluid and a valve for opening and closing the aperture, the valve being operable to modulate fluid ejection through the aperture at a frequency detectable by somatic sensors of a human finger.

2. A tactile display as in claim 1, wherein the valve of each pixel comprises a movable diaphragm.

3. A tactile display as in claim 1, wherein the valve of each pixel is a flap valve.

4. A tactile display as in claim 1, wherein the valve of each pixel has an actuator formed of an electro-active polymer.

5. A tactile display as in claim 1, wherein the pixels have a size of 0.5 mm or less.

6. A tactile display as in claim 1, wherein the touch surface layer includes a flexible membrane covering the apertures of pixels, the membrane forming a bump in response to fluid pressure from the aperture of a pixel.

7. A tactile display as in claim 1, wherein the touch surface layer includes a layer of a porous material covering the apertures of the pixels.

8. A display system for providing tactile feedback, comprising:
a tactile display having a touch surface layer having a plurality of pixels, each pixel having an aperture for ejecting a fluid and a valve for opening and closing the aperture, the valve being operable to modulate fluid ejection through the aperture at a frequency detectable by somatic sensors of a human finger; and
a fluid supply connected to the tactile display for providing the fluid to the tactile display.

9. A display system as in claim 8, wherein the valve of each pixel comprises a movable diaphragm.

10. A display system as in claim 8, wherein the valve of each pixel is a flap valve.

11. A display system as in claim 8, wherein the valve of each pixel comprises an actuator formed of an electro-active polymer.

12. A display system as in claim 8, further including a device for heating or cooling the fluid to change a temperature of the fluid ejected by the tactile display.

13. A display system as in claim 8, wherein the pixels have a size of 0.5 mm or less.

14. A display system as in claim 8, wherein the touch surface layer includes a flexible membrane covering the apertures of pixels, the membrane forming a bump in response to fluid pressure from the aperture of a pixel.

15. A display system as in claim 8, wherein the touch surface layer includes a layer of a porous material covering the apertures of the pixels.
